(19) United States
(12) Patent Application Publication
(10) Pub. No.: US 2024/0237823 A1
(43) Pub. Date: Jul. 18, 2024

(54) Rail and Rack with Rail

(71) Applicant: Max WINKLER, Graz (AT)

(72) Inventor: Max WINKLER, Graz (AT)

(21) Appl. No.: 18/412,456

(22) Filed: Jan. 12, 2024

(30) Foreign Application Priority Data
Jan. 12, 2023 (DE) 10 2023 100 596

(51) Int. Cl. A47B 96/14

(52) U.S. Cl. CPC A47B 96/14

(57) ABSTRACT

A rail, in particular for a rack of a rack storage system, wherein the rail extends along a longitudinal axis and the rail has a cross-sectional profile with at least three legs, such that a first of the legs is a guiding surface leg which, together with the longitudinal axis of the rail, spans a guiding surface for a storage machine, a second of the legs is a guiding surface leg which, together with the longitudinal axis of the rail, spans a guiding surface, and a third of the legs is a rack upright leg which, together with the longitudinal axis of the rail, spans a mounting surface for a rack upright. The running surface leg is cut at an front face edge of the rail in a first sectional plane, the first sectional plane being pivoted about a surface normal of the running surface.

### CROSS REFERENCE TO RELATED APPLICATIONS

This application claims, under 35 U.S.C. § 119(a)-(d) and 37 C.F.R. § 1.55, a benefit of priority, including filing date, to German Patent Application No. DE 10 2023 100 596.0, filed Jan. 12, 2023, titled “Fahrschiene sowie Regal mit Fahrschiene” (“Rail and Rack with Rail”), the entire contents of which are hereby incorporated by reference herein, for all purposes.

### BACKGROUND

### Technical Field

The subject matter relates to a rail and a rack or rack storage system with such a rail.

### Related Art

Racks and rack storage systems for automatic storage and retrieval of goods using storage machines, which are supported on the racks by means of rails attached to the rack and are moved along the rails, are well known. The storage machines considered here are also referred to as storage automats, shuttles, mini-shuttles, slides, caterpillars, or storage and retrieval machines. Storage machines considered here can store and retrieve unit loads, bulk goods, trays, baskets, boxes, cartons, or the like.

The rack and rack storage systems considered here, commonly also referred to as rack systems or rack constructions, are usually bolted and/or plugged assemblies made of sheet metal profiles. These rack constructions are subject to typical steel construction tolerances, defined among other things by the FEM9.831 standard. This standard results in tolerances of ±3 mm for the bay length, i.e. the horizontal rack grid between two rack uprights. A rack grid usually has a bay length of between 2 m and 4 m. This means that uprights are mounted at these distances within the rack grid.

The rails considered here, which are supported on such a rack construction, are typically mounted with lengths of between approx. 4 and approx. 9 m. Normally, one length of a rail corresponds to one rail segment. A rail segment usually spans an integer multiple of the bay length of the rack grid. To avoid misunderstandings, it is pointed out that a rail within the meaning of this application is also referred to by experts as a rail segment and that several rail segments together form an aisle. Here, however, a rail is a segment. Several rails can be arranged one behind the other. Several rail segments (referred to here as rails) can be arranged one after the other along a rack. It is therefore possible that N segments (referred to here as rails) of x m each form a total rail (referred to here as an aisle) of N*x m. Typically, a rail segment (i.e. the segment formed from several rails) is made up of 2 to 3 rails.

A rack storage system usually extends over a large number (e.g. N=2 to 3, as described above) of bay lengths, so that more than one rail regularly extends along an extension of a rack storage system in a horizontal plane. This results in joints between abutting rails. These are usually arranged so that the joints are in the areas of rack uprights. The rails are attached to the uprights. In a horizontal plane of a rack storage system, rails, aisles, or the like can preferably extend in a longitudinal direction or a transverse direction, whereby these two directions are preferably perpendicular to each other. An aisle can also be referred to as a running aisle or storage aisle. A storage machine can be moved along a track or a lane in either the longitudinal or transverse direction.

Even with the tightest tolerance for rails of this length class in accordance with DIN ISO 2768, tolerance class m, the permissible length tolerance of the rail is ±3 mm. The permitted tolerances for rack and rails therefore result in a tolerance width of 0 to 12 mm for the rail joint at a boundary between two rails. While vertical tolerances can be largely compensated for during assembly by means of corresponding vertical slots, e.g. in the mounting surfaces of the rails or the uprights, this is not possible along the horizontal axes of the rails.

A standard-compliant design of uprights and rails in a rack storage system therefore results in an average gap of 6 mm at the joint of two rails, with permissible maximum values of more than 10 mm. This gap leads to a corresponding immersion of the running and/or guiding wheels of the storage machine when passing over the rail joint.

Mini shuttles are used as storage machines in warehouses for small load carriers, e.g. cartons, trays, and plastic containers with base dimensions of approx. 400×300 mm to approx. 800×600 mm, for example. For these mini-shuttles, running and driving wheels with a diameter of between 40 and 100 mm are usually used. This results in an immersion depth of 0.23 to 0.1 mm with a 6 mm gap and an immersion depth of 0.92 to 0.36 mm with a 12 mm gap. From a purely static point of view, i.e. without taking into account the effect of the moving mass of the storage machine, a horizontal force of between 18.5 N and 8.2 N (6 mm gap) and between 37.7 N and 14.8 N (12 mm gap) per wheel can be calculated for a storage machine with a mass of 100 kg.

The presence of this horizontal force also means that the impact represents an obstacle to the movement of the storage machine along the rail. This means that the forces described above are additionally increased by the deceleration of the moving mass of the storage machine due to the impact.

Due to the storage machines moving along the rail segments on the rails, this force is introduced into the rack at the joints between the rails in a jerky manner. These jolts or jerky force transmissions that occur repeatedly during operation of the storage machines lead to corresponding shocks and vibrations in the rack. As a result, light and rigid stored goods, especially empty or almost empty load carriers (storage containers), e.g. made of plastic, undergo small changes in position. Since the tolerances given by the FEM9.831, among other things, mean that the storage locations in the rack are usually never perfectly horizontal, a large number of successive small changes in position result in a directional movement of the stored goods, especially stiff and light ones. This effect is also referred to as “dancing totes” in technical jargon.

### SUMMARY OF EMBODIMENTS

An object of the present invention is an improved rail designed to minimize the movement of, in particular, stiff and/or light stored goods caused by the storage machines of the storage machines moving along the rails as well as other attachments, in particular while maintaining the design specifications of the rack.

This object is solved by a rail, a rack, and a method as described and claimed herein.

Embodiments of the present invention reduce, minimizes, or completely prevent the above-described introduction of force due to the rollers plunging into the gaps. The solution in question considerably reduces the forces introduced into the rack by the mechanical movement of the storage machines and the resulting mechanical loads on the stored goods and the rack compared to conventional solutions. Rails of two adjacent rail segments regularly have a distance between their front face edges. It has been shown that this gap no longer results in dancing totes, due to the disclosed and claimed configuration of the front face edges of the rails. The rollers can be guided essentially without jerking over such a gap with the disclosed and claimed configuration.

A rail has an extension along a longitudinal axis. A cross-sectional plane of the rail can be perpendicular to this longitudinal axis. A transverse axis and a vertical axis can extend in the cross-sectional plane. The vertical axis can be parallel to the surface normal of a running surface of the rail. The transverse axis can run perpendicular to the vertical axis and perpendicular to the longitudinal axis. The longitudinal axis, transverse axis and vertical axis can each be perpendicular to each other. The rail can have an extension along its longitudinal axis, which is a multiple of its extension along its transverse axis and its vertical axis. A running surface can also be referred to as a driving surface or rolling surface.

The rail can be a profiled, open tube. The rail can be a sheet metal profile. The rail can be formed from a sheet or strip. The rail can be a shaped, such as bent, folded, roll-formed, cold-rolled and/or extruded profile. The rail can also be referred to as a running rail.

A storage machine can be movably mounted on at least one rail for the storage and retrieval of goods in racks of a rack storage system. For example, two parallel rails can form a storage aisle along which the storage machine can move. A rack level can lie in a horizontal plane. In a rack level, two storage aisles running perpendicular to each other can be formed by two parallel rails. In vertically adjacent rack levels, alternating perpendicular storage aisles can be formed by two parallel rails. It is also possible to arrange rails between two vertically spaced rack levels to be able to move storage machines back and forth along these rails between the rack levels. A rack level can also be referred to as a storage level. The storage level and the level of an aisle can run parallel to each other.

A storage machine can be a motorized machine that moves along the rails. The storage machine can be designed to store and retrieve stored goods, e.g. unit loads, containers, packaging units or the like. The storage machine can be moved along the rail.

A cross-sectional profile through the rail runs along a cross-sectional plane. The cross-sectional plane can be spanned by the transverse axis and the vertical axis. The longitudinal axis of the rail can be the surface normal of the cross-sectional plane. In this cross-sectional profile, the rail has at least three legs. These three legs are preferably essentially perpendicular to each other. The three legs span a U-profile. However, it is possible for the rail to have more than three legs, in particular four or five legs. In particular, the cross-sectional profile can also be U-shaped or C-shaped.

The storage machine is moved in translation along the rail. The storage machine is movably mounted on the rail via rollers. The rollers rest on a running surface of the rail. The rollers are driven by a motorized drive to move the storage machine along the longitudinal axis of the rail. Rollers can also be referred to as drive rollers, drive wheels, running wheels, or the like. The rollers can be mechanically coupled to the drive, such as to a motor, and can use this to move the storage machine along the rail. The motor is usually an electric motor. The motor is usually powered by an external supply, with at least one conductor rail arranged in or on the rail. There are also self-powered storage machines, e.g. by means of a battery, a rechargeable battery, or a capacitor, e.g. a super-cap, in which case a conductor rail along the rail can be omitted. The conductor rail can be arranged in or on the rail, insulated from the material of the rail. The storage machine can draw electrical power from the conductor rail via an electrical consumer and use this to drive the motor.

For storage machines that move along rails in the rack, a distinction is made between two different types of rollers or wheels. Firstly, track rollers, which bear the weight of the storage machine and the conveyed goods. Track rollers can also be drive rollers or rollers without drive. Particularly in the case of storage machines that move along more than one axis in the rack storage, the running wheels are either multiple, e.g. vertically offset and with a lifting/lowering device, or the running wheels are designed to be steerable or rotatable. Secondly, the storage machine has guide rollers. Guide rollers are typically arranged perpendicular to the track rollers and typically guide the storage machine along the rail by supporting it on a guiding surface or a guide web of the rail.

One leg of the rail is a running surface leg. A running surface for the storage machine can be spanned by the extension axis of the running surface leg and the longitudinal axis of the rail. The extension axis of the running surface leg can be formed by the transverse axis. The running surface lies in the plane spanned by the extension axis of the running surface leg and the longitudinal axis of the rail. The rollers can rest on the running surface leg and move along the rail.

To guide the storage machine along the longitudinal axis of the rail and to hold the rollers on the running surface during movement, the rail has a guiding surface leg. The guiding surface leg extends in an extension axis at an angle, preferably at a right angle to the running surface leg. The extension axis of the guiding surface leg can be formed by the vertical axis. A guiding surface for the storage machine can be spanned by the extension axis of the running surface leg and the longitudinal axis of the rail. The guiding surface lies in the plane spanned by the extension axis of the running surface leg and the longitudinal axis of the rail. At least one guide means, such as a guide roller, is located on the guiding surface leg. Preferably, one guide means is located on each of the opposite sides of the guide leg. The guide means are guided on the guide leg along the longitudinal axis of the rail, so that the storage machine is moved along the trajectory of the guiding surface.

Mounting on a rack upright is preferred for attaching the rail to the rack. For this purpose, the rail is usually bolted to the rack upright by a screw. To prevent movement of the storage machine being hindered by this screw connection, a rack upright leg is provided on the rail. The rack upright leg forms a mounting surface for attaching the rail to the rack upright. The rack upright leg extends along an axis at an angle, preferably at right angles to the running surface leg. The extension axis of the rack upright leg can be formed by the vertical axis. The rack upright leg extends along an extension axis, preferably essentially parallel to the guiding surface leg.

The running surface leg is preferably located between the guiding surface leg and the rack upright leg. The cross-sectional profile of the guiding surface leg, the running surface leg and the rack upright leg form a U. A mounting surface for the rail on a rack upright is spanned by the extension axis of the rack upright leg and the longitudinal axis of the rail. The mounting surface lies in the plane spanned by the extension axis of the rack upright leg and the longitudinal axis of the rail.

Preferably, the running surface leg is adjacent to the rack upright leg. Furthermore, the guiding surface leg preferably runs parallel to the rack upright leg. The guiding surface leg can be adjacent to the running surface leg. The rack upright leg and/or the guiding surface leg can be beveled to give the profile increased stability.

A problem with known rails is caused by their joints, i.e. the transitions between two rails or rail segments along an aisle. As already described above, dynamic vibrations occur at the transitions due to the rollers plunging into the gaps between the rails. The immersion depth of the roller depends on the width of the gap and the diameter of the roller. The horizontal force that must be applied to move the roller out of the gap after immersion depends on the immersion depth and the mass of the storage machine as well as any goods stored on the storage machine.

A rail is now proposed which can significantly reduce or even completely prevent the roller from plunging into the gap at a joint between two rail segments. In this way, the disadvantages described above associated with immersion can be reduced. A joint between two adjacent rails at a transition between two rail segments does not mean that the rails necessarily touch at the front faces. Within the dimensional tolerance of the length of the rails, a gap is usually formed between the rails at a joint. However, contact can also occur within the tolerance. However, as a gap between two adjacent rails is always possible due to the tolerance, the design of the front face edge of a rail described below is proposed. When referring to a front face edge, this can mean the edge between a surface and the front face or the front face itself. The term front face edge can also be understood as the front face of the rail and vice versa.

It is proposed that the running surface leg is cut at a front face edge of the rail in a first sectional plane, the first sectional plane being pivoted about a surface normal of the running surface. The rail ends at its front face edge. It is proposed that the edge runs at an angle to the longitudinal axis of the rail. It is proposed that the sectional plane and thus the front face of the rail is pivoted about the surface normal of the running surface. This means that the sectional plane, along which the rail is cut to length, is angled to the longitudinal axis of the rail and pivoted about a surface normal of the running surface. Pivoting can mean twisting or rotating by an angle. Pivoting can also mean angling.

By pivoting the front face edge around the surface normal of the running surface, two adjacent rails can overlap along their longitudinal axis in the area of the respective front face edges. When the following refers to swiveling, pivoting or rotating around an axis, e.g. the surface normal, this means that the axis is the axis of rotation, i.e. a rotation or pivoting around this axis takes place. The terms pivoting, swiveling or rotating can be used synonymously. By pivoting the edge, two adjacent rails can overlap in relation to the transverse axis. This overlap means that a track roller does not dip into a gap that forms, or only dips into it to a small extent. Although the gap between the two adjacent rails is not always nominally reduced, the roller essentially always rests on the running surface of at least one of the two adjacent rails in the area of the gap. The rolling surface of the track roller generally rests on the running surface of a rail. In the area of the gap, a part of the rolling surface of a track roller rests on a running surface of a first rail on a first side and a part rests on a running surface of an adjacent rail on an opposite side. In the area of the gap, the roller therefore always rests on at least one, in most cases both, of the adjacent rails. The support of the roller on the running surface of the rail extends beyond the front face edge. The roller preferably rests on an area of the running surfaces of two adjacent rails that is not formed solely by the front face edge of the running surface. The roller therefore no longer dips into the gap between the running surfaces.

According to an embodiment, it is proposed that the first sectional plane runs parallel to the surface normal of the running surface. This sectional plane makes it particularly easy to manufacture the rail. The two rails overlap along the transverse axis of the rails.

According to an embodiment, it is proposed that the first sectional plane is pivoted about a transverse axis. The sectional plane then runs at an angle to the surface normal of the running surface. This sectional plane is particularly advantageous if the front face edge of the guiding surface is also pivoted about the transverse axis, as described below. In particular, a cut can then be made along a single sectional plane through both the running surface and the guiding surface.

The front face edges of the running surface and the guiding surface preferably run along the same straight line. By pivoting the front face edge around the surface normal of the running surface, two adjacent rails can overlap along their longitudinal axis in the area of the respective front face edges. By pivoting the edge, two adjacent rails can overlap in relation to the transverse axis. This overlapping means that a track roller does not dip into a gap that forms, or does so only to a small extent. By pivoting the front face edge around the transverse axis of the running surface, two adjacent rails can overlap along their vertical axis in the area of the respective front face edges. By pivoting the edge, two adjacent rails can overlap in relation to the vertical axis.

According to an embodiment, it is proposed that the first sectional plane is pivoted by 30° to 60° around the surface normal of the running surface. It has been found that a minimum angle of 30° ensures that even smaller rollers on the market do not dip into the gap. A maximum angle of 60° ensures that the overlap along the longitudinal axis is not too large.

However, the more acute the angle and therefore the cut, the more acute and thinner the cut profile becomes. And the sharper and therefore thinner the cut profile is, the more unstable it becomes. In addition to the resulting increased risk of injury during installation, the static weakening of the profile tip leads above all to an undesirable source of vibrations.

According to one embodiment, it is proposed that the first sectional plane is pivoted by 30° to 60° around the transverse axis of the running surface. It has been found that a minimum angle of 30° ensures that even smaller rollers on the market do not dip into the gap. A maximum angle of 60° ensures that the overlap along the longitudinal axis is not too large and that the mechanical stability of the rail is not impaired too much, as described above.

The first sectional plane can also be pivoted about both the surface normal of the running surface and the transverse axis of the running surface in the manner described.

According to an embodiment, it is proposed that the guiding surface leg is cut at the front face edge of the rail in a second sectional plane, the second sectional plane being pivoted about a surface normal of the guiding surface. The second sectional plane can thus be pivoted about the transverse axis of the running surface. The second sectional plane runs at an angle to the longitudinal axis of the rail. By pivoting the front face edge, two adjacent rails can overlap along their longitudinal axis in the area of the respective front face edges of the guiding surfaces. By pivoting the edge of the guiding surface, two abutting rails can overlap with their guiding surfaces in relation to the vertical axis. This overlapping means that a guide roller does not or only to a small extent dips into a gap that forms on the guiding surface.

According to an embodiment, it is proposed that the second sectional plane is parallel to the surface normal of the guiding surface. This sectional plane makes it particularly easy to manufacture the rail.

According to an embodiment, it is proposed that the second sectional plane is pivoted about a surface normal of the running surface. The second sectional plane runs at an angle to the longitudinal axis of the rail. This sectional plane is particularly advantageous if, as described above, the front face edge of the running surface is also pivoted about the surface normal of the running surface. In particular, a cut can then be made along a single sectional plane through both the running surface and the guiding surface. The front face edges of the running surface and the guiding surface preferably run along the same straight line.

According to an embodiment, it is proposed that the second sectional plane is pivoted by 30° to 60° about the surface normal of the guiding surface and/or transverse axis of the running surface. It has been found that a minimum angle of 30° ensures that even the smallest guide rollers located around the market do not dip into the gap. A maximum angle of 60° ensures that the overlap along the longitudinal axis is not too large and that the mechanical stability of the rail is not impaired too much, as described above.

According to one embodiment, it is proposed that the second sectional plane is pivoted by 30° to 60° around the surface normal of the running surface. It has been found that a minimum angle of 30° ensures that even the smallest guide rollers located around the market do not dip into the gap. A maximum angle of 60° ensures that the overlap along the longitudinal axis is not too large and that the mechanical stability of the rail is not impaired too much, as described above.

According to one embodiment, it is proposed that the first and second sectional planes are identical. In this case, the production of the rail is particularly simple, as the cut through the running surface and the guiding surface can be made in just one operation. There is no need to set a cutting tool for two different sectional planes.

According to an embodiment, it is proposed that the rack upright leg is cut at the front face edge of the rail in a third sectional plane. It is proposed that the surface normal of the third sectional plane is parallel to the longitudinal axis of the rail. In order to attach the rail to the rack upright, the rail has openings in the area of the rack upright leg to accommodate fastening means. In particular, holes or elongated holes can be provided to accommodate fasteners, especially screws, in order to fix the rail to the rack upright with the aid of the fasteners. The use of slotted holes can compensate for tolerances in the vertical direction. If the third sectional plane were pivoted around the transverse axis of the rail, the cut on the rack upright would be at an angle. It would then be more difficult to attach the rail to the rack upright, as the fasteners would then have to be attached to the rack upright offset upwards or downwards depending on the direction of the cut. This in turn would require a correspondingly offset hole pattern on the rack upright. It therefore makes sense for the third sectional plane to run parallel to the surface normal of the running surface and, in particular, to be vertical in the assembled state.

According to an embodiment, it is proposed that the front face edges arranged at ends of the rail are each cut in the first, second and/or third sectional planes, with the respective sectional planes running parallel to one another at the respective ends. The ends of the rail are preferably cut along sectional planes running parallel to each other. As a result, the front face edges of the ends run parallel to each other.

According to an embodiment, it is proposed that the guiding surface leg and the running surface leg are angled in cross-section, in particular at right angles to each other. The storage machine can be moved on the running surface by means of at least one, preferably two, rollers. A guiding surface can be provided to guide the storage machine along the longitudinal axis of the rail. The guiding surface can be formed by the guiding surface leg. A guide means can be arranged on this guiding surface. In particular, guide means are provided on both sides of the guiding surface leg. If the guiding surface leg and the running surface leg are perpendicular to each other, the axes of rotation of the roller and the guide roller can also be perpendicular to each other. The guide rollers are guided on the guiding surface leg and thus ensure that the rollers are guided on the running surface.

According to an embodiment, it is proposed that the guiding surface leg and the rack upright leg are essentially parallel to each other in cross-section. This enables a compact design of the rail. In addition, this arrangement is advantageous for guiding the guide rollers of known storage machines along the guiding surface leg.

According to an embodiment, it is proposed that the rack upright leg (and thus in particular also the mounting surface) is folded in an L-shape in such a way that a folded area runs essentially parallel to the running surface. Bending the rack upright leg on the side facing away from the running surface leads to an increase in the surface moment of inertia of the rail and thus to increased rigidity of the rail.

It is also proposed that the rack upright leg is folded in a U-shape in such a way that a first leg of the folded area runs essentially parallel to the running surface and a second leg of the folded area runs essentially parallel to the mounting surface. This further pivoting along the side facing away from the running surface leads to further stiffening of the driving rail.

A further aspect is rack with a first rail as described above and a second rail as described above, wherein the rails run in the longitudinal direction in the same rack plane and are arranged with their front face edges abutting one another in such a way that the sectional planes of the first and second rails are essentially parallel to one another. This optimizes the transition between the track segments with regard to the immersion of the rollers. The two assigned front faces of the rails are congruent to each other at the joint.

According to one embodiment, it is proposed that rails of two adjacent rail segments are mounted on the rack with a distance between their front face edges of less than 20 mm, preferably less than or equal to 12 mm. It has been shown that a gap of less than 20 mm, in particular less than 12 mm, is tolerable due to the described configuration of the front face edges of the rails. The rollers can be guided essentially smoothly over such a gap with the claimed configuration.

According to an embodiment, it is proposed that a rail is mounted with its mounting surface on a rack upright. This allows the rails to be fixed to the rack.

According to an embodiment, it is proposed that two rails arranged parallel to each other in the longitudinal direction and at a distance from each other in the transverse direction in the same rack level form a rail segment of a lane. The storage machine can be mounted on two parallel rails of an aisle.

According to an embodiment, it is proposed that rail segments in the same rack level run parallel to a longitudinal axis of the rack level. These track segments can form longitudinal aisles of the rack. It is also proposed that rail segments in the same rack level run transversely to the longitudinal axis of the rack level. These track segments can form transverse aisles of the rack. It is also proposed that at least one rail segment runs at an angle to the rack level and connects two vertically offset rack levels. With such a rail segment, it is possible to move a storage machine between two vertically spaced rack levels.

An embodiment of the present invention provides a rail for a rack of a rack storage system of the kind that includes a rack upright. The rail extends along a longitudinal axis. The rail has a cross-sectional profile with at least three legs.

A first leg of the at least three legs is a running surface leg. The running surface leg, together with the longitudinal axis of the rail, spans a running surface for a storage machine. At each point along the rail, a transverse axis extends perpendicular to the longitudinal axis at the point and parallel to the running surface. Thus, the running surface follows the longitudinal axis.

A second leg of the at least three legs is a guiding surface leg. The guiding surface leg, together with the longitudinal axis of the rail, spans a guiding surface.

A third leg of the at least three legs is a rack upright leg. The rack upright leg, together with the longitudinal axis of the rail, spans a mounting surface for the rack upright.

The running surface leg is cut at a first front face edge of the rail by a first sectional plane. The first sectional plane is pivoted a non-zero angle, relative to the transverse axis, about a surface normal of the running surface.

Optionally, in any embodiment, the first sectional plane is parallel to the surface normal of the running surface or the first sectional plane is pivoted about the transverse axis.

Optionally, in any embodiment, the first sectional plane is pivoted by 30° to 60° about the surface normal of the running surface and/or the first sectional plane is pivoted by 30° to 60° about the transverse axis.

Optionally, in any embodiment, the guiding surface leg is cut at a second front face edge of the rail by a second sectional plane, the second sectional plane being pivoted about the transverse axis.

Optionally, in any embodiment in which the guiding surface leg is cut at a second front face edge of the rail by a second sectional plane, the second sectional plane is parallel to the transverse axis or the second sectional plane is pivoted about the surface normal of the running surface.

Optionally, in any embodiment in which the guiding surface leg is cut at a second front face edge of the rail by a second sectional plane, the second sectional plane is pivoted by 30° to 60° about the surface normal of the running surface and/or the second sectional plane is pivoted by 30° to 60° about the transverse axis.

Optionally, in any embodiment in which the guiding surface leg is cut at a second front face edge of the rail by a second sectional plane, the first and second sectional planes are identical.

Optionally, in any embodiment, the rack upright leg is cut at a third front face edge of the rail by a third sectional plane. A surface normal of the third sectional plane is parallel to the longitudinal axis.

Optionally, in any embodiment in which the rack upright leg is cut at a third front face edge of the rail by a third sectional plane, the first, second and third sectional planes are parallel to one another.

Optionally, in any embodiment in which the guiding surface leg is cut at a second front face edge of the rail by a second sectional plane, the first and second section planes are parallel to one another.

Optionally, in any embodiment, the third leg comprises an L-shape. A first portion of the third leg runs essentially parallel to the running surface and/or the third leg comprises a U-shape such that a first portion of the third leg runs essentially parallel to the running surface and a second portion of the third leg runs essentially parallel to the mounting surface.

Another embodiment of the present invention provides a rack storage system. The rack storage system includes a first rail. The first rail extends along a longitudinal axis. The first rail has a cross-sectional profile with at least three legs.

A first leg of the at least three legs is a running surface leg The running surface leg, together with the longitudinal axis of the rail, spans a running surface for a storage machine. At each point along the rail, a transverse axis extends perpendicular to the longitudinal axis at the point and parallel to the running surface.

A second leg of the at least three legs is a guiding surface leg. The guiding surface leg, together with the longitudinal axis of the rail, spans a guiding surface.

A third leg of the at least three legs is a rack upright leg. The rack upright leg, together with the longitudinal axis of the rail, spans a mounting surface for a rack upright.

The running surface leg is cut at a first front face edge of the rail by a first sectional plane. The first sectional plane is pivoted, relative to the transverse axis, about a surface normal of the running surface.

The rack storage system also includes a second rail. The second rail extends along a longitudinal axis. The second rail has a cross-sectional profile with at least three legs.

A first leg of the at least three legs is a running surface leg. The running surface leg, together with the longitudinal axis of the rail, spans a running surface for a storage machine. At each point along the rail, a transverse axis extends perpendicular to the longitudinal axis at the point and parallel to the running surface.

A second leg of the at least three legs is a guiding surface leg. The guiding surface leg, together with the longitudinal axis of the rail, spans a guiding surface.

A third leg of the at least three legs is a rack upright leg. The rack upright leg, together with the longitudinal axis of the rail, spans a mounting surface for a rack upright.

The running surface leg is cut at a first front face edge of the rail by a first sectional plane. The first sectional plane is pivoted, relative to the transverse axis, about a surface normal of the running surface.

The first and second rails run in the longitudinal direction in a common rack plane. The first and second rails are arranged with their respective front face edges abutting each other. The respective sectional planes of the first and second rails are substantially parallel to each other.

Optionally, any embodiment of the rack storage system includes a plurality of first rails and a plurality of second rails. Each first rail is adjacent a respective second rail to form a respective pair of adjacent first and second rails. Each pair of adjacent first and second rails runs in the longitudinal direction in a common rack plane. Each pair of adjacent first and second rails is arranged with their respective front face edges abutting each other.

The respective sectional planes of the respective first and second rails are substantially parallel to each other. A distance between their respective front face edges is less than 20 mm.

Optionally, in any embodiment of the rack storage system, the distance between their respective front face edges is less than or equal to 12 mm.

Optionally, any embodiment of the rack storage system may include another first rail. The other first rail is disposed in the common rack plane with the first rail. The other first rail is parallel to the first rail. The other first rail is spaced in the transverse direction apart from the first rail. The first rail and the other first rail collectively form a rail segment of an aisle.

The rack storage system according to claim 15, further comprising:

Optionally, any embodiment of the rack storage system that includes a rail segment of an aisle may include a plurality of rail segments running in a common rack plane parallel to a longitudinal axis of the rack plane and/or a plurality of rail segments running in a common rack plane transversely to the longitudinal axis of the rack plane and/or at least one rail segment running at a non-zero angle to the rack plane and that connects two rack planes which are offset vertically relative to one another.

### BRIEF DESCRIPTION OF THE DRAWINGS

The invention will be more fully understood by referring to the following Detailed Description of Specific Embodiments in conjunction with the Drawings, of which:

FIG. 1 is a perspective view of a conventional rail, according to the prior art.

FIG. 2 is a cross-sectional view through the rail of FIG. 1.

FIG. 3 is a perspective view of an exemplary rack storage system with transverse and longitudinal aisles, according to an embodiment of the present invention.

FIG. 4 is a perspective view of another exemplary rack storage system with transverse and longitudinal aisles, according to an embodiment of the present invention.

FIG. 5 is a perspective view of the rail of FIG. 2 with three different sectional planes, according to various embodiments of the present invention.

FIG. 6 is a perspective view of a rail joint at a transition between two rail segments, sectioned according to FIG. 5, according to an embodiment of the present invention.

FIG. 7 is a perspective view of a rail, sectioned according to FIG. 5, with two ends, according to an embodiment of the present invention.

FIGS. 8-14 are respective cross-sectional views of several rail profiles according to respective embodiments of the present invention.

FIG. 15 is a perspective view of a rail joint, for example as illustrated in FIG. 6, at a transition between two rail segments according to an embodiment of the present invention.

FIG. 16 is a bottom perspective view of the rail joint of FIG. 15.

FIG. 17 is a perspective view of a rail joint at a transition between two rail segments according to another embodiment of the present invention.

FIG. 18 is a bottom perspective view of the rail joint according to FIG. 17.

### DETAILED DESCRIPTION OF SPECIFIC EMBODIMENTS

The subject matter relates to an improved design of rails in rack storage systems for storage machines in warehouses, in particular for rails that are supported on or in the rack structure. Such systems are known, for example, from European Publication EP 0 733 563 A1 and German Publication DE 101 423 95 A1, the entire contents of each of which are hereby incorporated by reference herein, for all purposes.

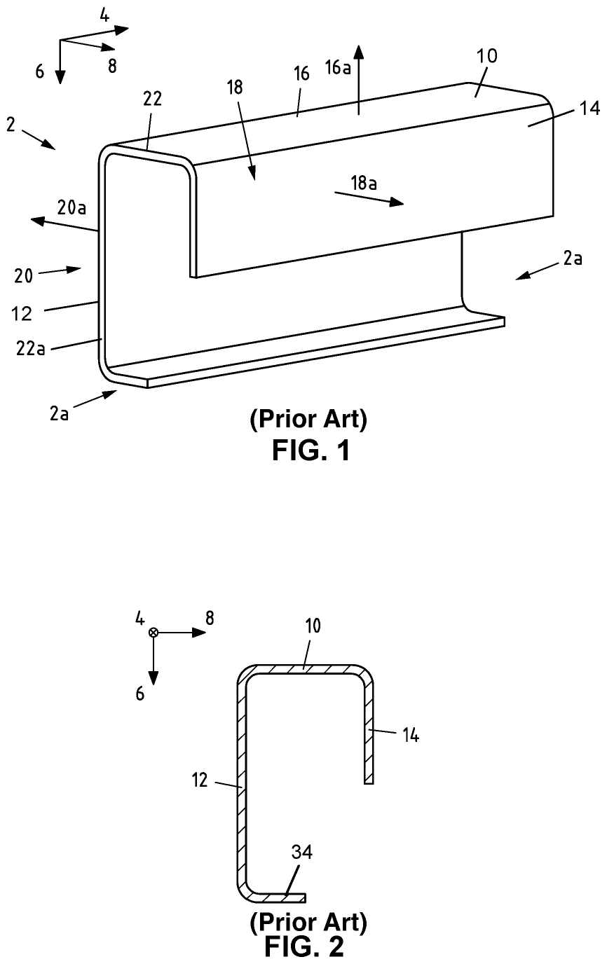

FIG. 1 shows a conventional rail 2. To facilitate descriptions herein, several axes, directions, planes, legs, and the like are first described, relative to the rail 2. This description is not intended to be exhaustive, and deviations from it are possible within the scope of the description here. Nevertheless, the following description serves as a point of reference for the axes, directions, planes, legs, and the like mentioned in this document.

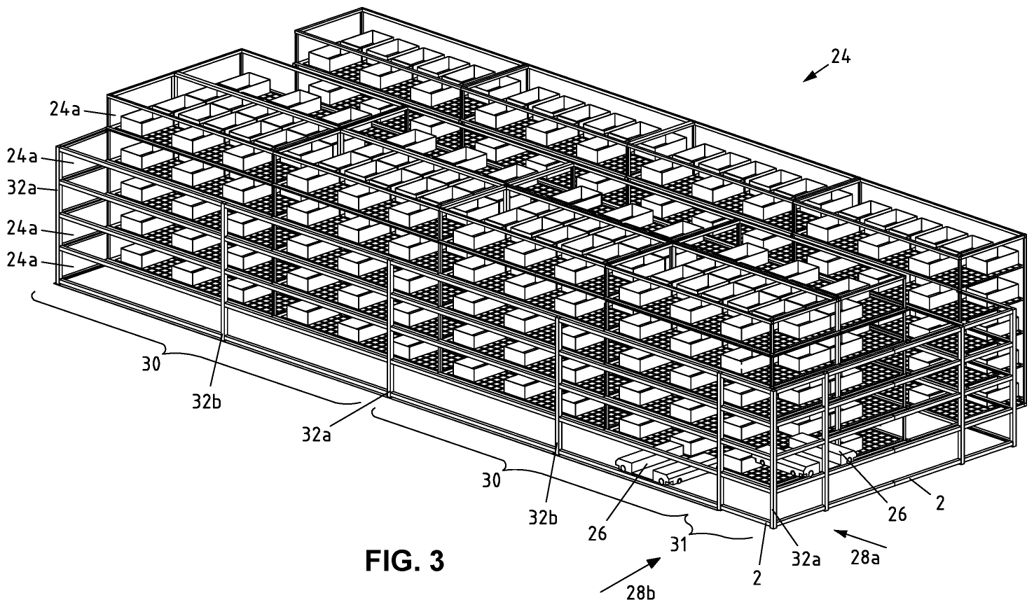

The rail 2 extends along a longitudinal axis 4. A vertical axis 6 and a transverse axis 8 run perpendicular to the longitudinal axis 4. In FIG. 2, which shows a cross-section through the rail 2, the longitudinal axis 4 runs perpendicular to the drawing plane. The vertical axis 6 and the transverse axis 8 can also be seen. Although a straight rail 2 is shown, the rail, or a portion thereof, may be straight or curved. In either case, the longitudinal axis 4 follows the track of the rail 2. Thus, the longitudinal axis 4 may be curved, but at each point along the rail 2, the longitudinal axis 4 extends in the same direction as the rail 2. In other words, at each point along the longitudinal axis 4, the longitudinal axis 4 corresponds to the instantaneous direction of the rail 2. At each point along the rail 2, the transverse axis 8 is perpendicular to the longitudinal axis 4 at a corresponding point of the longitudinal axis 4.

Longitudinal axis 4, vertical axis 6 and transverse axis 8 can also be understood as longitudinal direction 4, vertical direction 6, and transverse direction 8. The terms axis and direction can be used synonymously. The vertical axis 6 and the transverse axis 8 span (define) a cross-sectional plane. A cross-section along the cross-sectional plane through the rail 2 is shown in FIG. 2.

FIG. 2 shows that the rail 2 has several legs. A first leg can be understood as the running surface leg 10. The running surface leg 10 extends along the transverse axis 8. A rack upright leg 12 can adjoin the running surface leg 10. The rack upright leg 12 extends along the vertical axis 6. A guiding surface leg 14 can extend from the side of the running surface leg 10 opposite the rack upright leg 12. The guiding surface leg 14 extends along the vertical axis 6. The guiding surface leg 14 and the rack upright leg 12 can run parallel to each other. A folded edge 34 can be provided on the rack upright leg 12 on the side facing away from the running surface leg 10. The folded edge 34 shown is L-shaped, but a U-shaped folded edge 34 is also possible.

As shown in FIG. 1, the running surface leg 10 defines a running surface 16, which runs along a plane spanned by the transverse axis 8 and the longitudinal axis 4. The guiding surface leg 14 defines a guiding surface 18, which runs along a plane spanned by the longitudinal axis 4 and the vertical axis 6. The rack upright leg 12 defines a mounting surface 20, which runs along a plane parallel to the plane spanned by the longitudinal axis 4 and the vertical axis 6.

A surface normal 16a of the guiding surface 16 runs parallel to the vertical axis 6 and perpendicular to the running surface 16. A surface normal 18a of the guiding surface 18 runs parallel to the transverse axis 8 and perpendicular to the guiding surface 18. A surface normal 20a of the mounting surface 20 runs parallel to the transverse axis 8. The surface normals 18a, 20a can be antiparallel to each other.

The rail 2 has two opposing ends 2a. A respective front face edge 22 is defined at each respective end 2a. At least a portion of the front face edge 22 is in the running surface 16. A front face 22a of the rail 2 is formed at the front face edge 22. The front face 22a is a surface defined by the end 2a of the rail 2, whereas the front face edge 22 is a line defined by the end 2a of the rail 2. Each leg 10, 12, and 14 has its own respective front face edge 22, although, in some contexts, collectively all the leg edges are referred to as a front face edge 22.

Definitions of the orientations, legs, axes, surfaces, surface normals, front faces, front face edges, and the like shown also apply to the following embodiments of the present invention. Compared to the rail shown in FIGS. 1 and 2, these embodiments have modified front face edges 22 and/or front faces 22a.

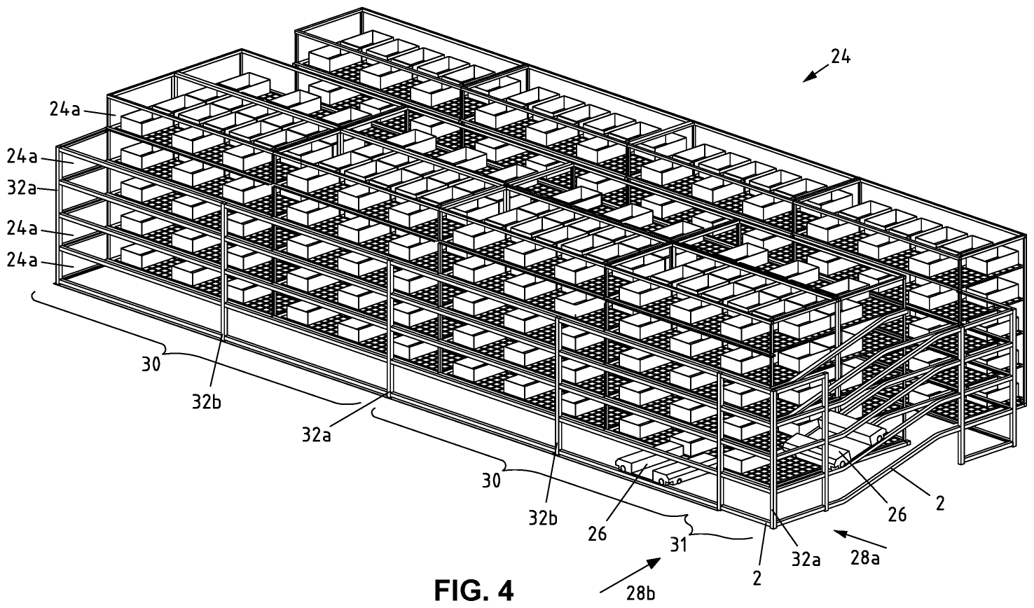

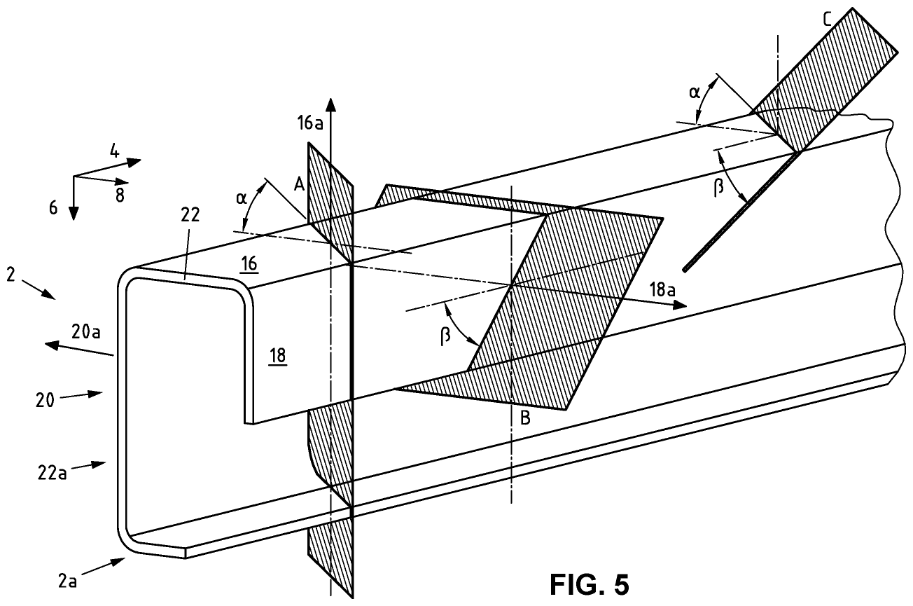

FIGS. 3 and 4 show respective high rack storage 24 systems. A plurality of rack levels 24a are arranged one above the other on the high rack storage 24 systems. In each of the rack levels 24a, storage machines 26 can move along aisles. Longitudinal aisles 28a and transverse aisles 28b can be formed by one or more rail segments. A rail segment can be formed by two rails 2 running parallel in a rack level 24. The storage machines 26 can be mounted on rollers on these rails 2. A longitudinal aisle 28a can be formed by several rail segments 30. Rail segments 30 can abut each other in the area of rack uprights 32a. A rail segment 30 can extend over several rack uprights 32a, 32b. In this case, for example, each second, third or fourth upright 32a is abutted by two adjacent rails 2. The adjoining rails 2 can each be attached to a rack upright 32a. The rails can also be attached to the rack uprights 32b. in prior art rack storage systems, at transitions (joints) between the rail segments 30, gaps are formed between adjacent rails 2. This applies to longitudinal aisles 28a as well as transverse aisles 28b. A rail segment 31 can also only extend between two uprights.

FIG. 3 shows two storage machines 26, each of which moves in a longitudinal aisle 28a and a transverse aisle 28b. The storage machines 26 can be guided on either a longitudinal aisle 28a or a transverse aisle 28b by means of suitable mechanisms on their rollers and guide rollers, which can be lowered and raised as required. Both in a longitudinal track 28a and in a transverse track 28b, adjacent rails 2 can abut each other. It should be noted that FIG. 3 and FIG. 4 only schematically show a high rack storage 24. It is important to note that it can be seen that two rails can adjoin each other in the longitudinal direction along an aisle and that there are joints. It should also be noted that a rail can extend over more than two rack upright spacings. Two rails 2 can join at a rack upright 32a.

FIG. 4 shows a high rack storage similar to FIG. 3 with the difference that vertical movement of a storage machine 26 is also possible in an aisle 28a, 28b. A rail 2 can extend between two vertically adjacent rack levels 24a and connect these levels 24a with each other. A storage machine 26 can thus be moved from one rack level 24a to another rack level 24a along a rail 2.

The present object was to reduce the effect of the rollers of the storage machines 26 plunging into such gaps. For this purpose, it is proposed that at least one, preferably both ends 2a of a rail 2, the front face edge 22 extends at a non-zero angle to the transverse axis, as shown in the following figures.

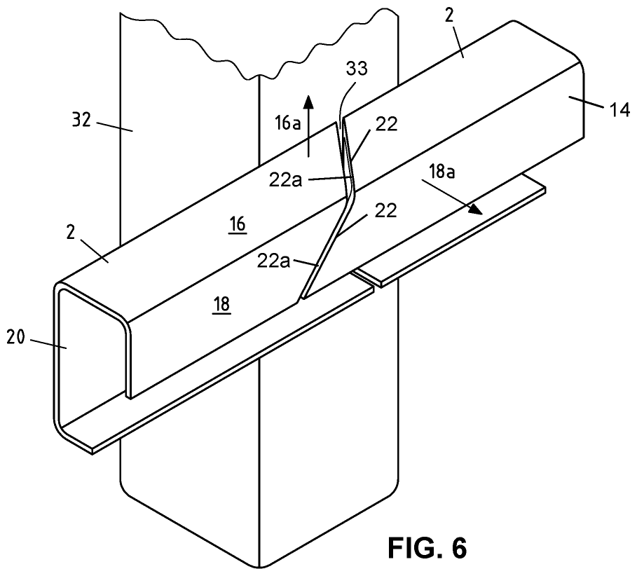

FIG. 5 shows three possible sectional planes through the rail 2.

A first sectional plane A can be seen. This first sectional plane A is parallel to the surface normal 16a of the running surface 16. In addition, this sectional plane A is oriented at a non-zero angle α to the transverse axis 8. Thus, the sectional plane A can be considered to be pivoted, by the non-zero angle α relative to the transverse axis 8, about the surface normal 16a.

A second sectional plane B is shown. This second sectional plane B is parallel to the surface normal 18a of the guiding surface 18. In addition, this sectional plane B is oriented at a non-90° angle β to the longitudinal axis 4. Thus, the sectional plane B can be considered to be pivoted, by the non-90° angle β relative to the longitudinal axis 8, about the surface normal 18a.

A third sectional plane C is shown. This third sectional plane contains a combination of the angles and/or rotations of the first and second sectional planes A and B. The third sectional plane C runs at a non-90° angle β to the longitudinal axis 4 and a non-zero angle α to the transverse axis 8. Thus, the sectional plane C can be considered to be pivoted about both the surface normal 18a and the surface normal 16a.

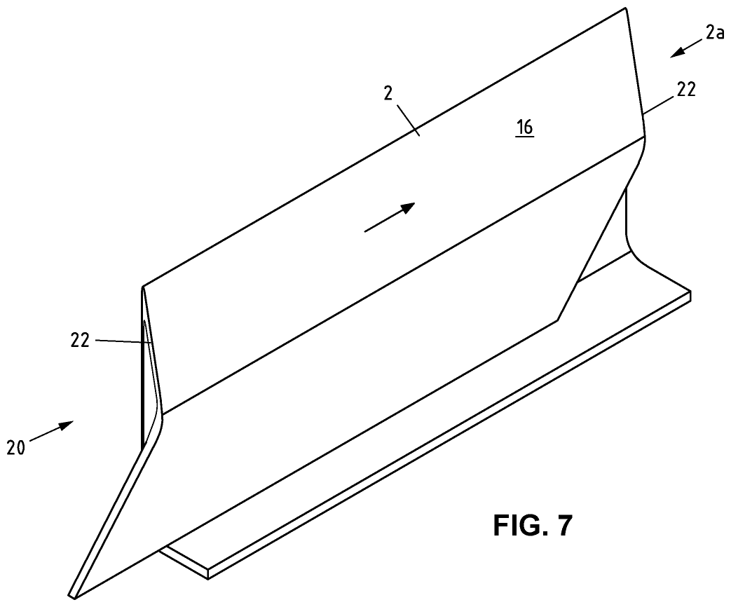

FIG. 6 shows a gap 33 at a joint between two rails 2, which are mounted on a rack upright 32. At least counterfacing end portions of the two rails 2 are each sectioned according to the sectional plane C described above.

The front face edge 22 on the running surface 16 runs at a non-zero angle to the surface normal 18a. The front face edge 22 of the guiding surface 14 runs at an angle to the surface normal 16a. The front face 22a on the running surface 16 runs at an angle to the transverse axis 8. The front face 22a of the guiding surface 14 runs at an angle to the surface normal 16a.

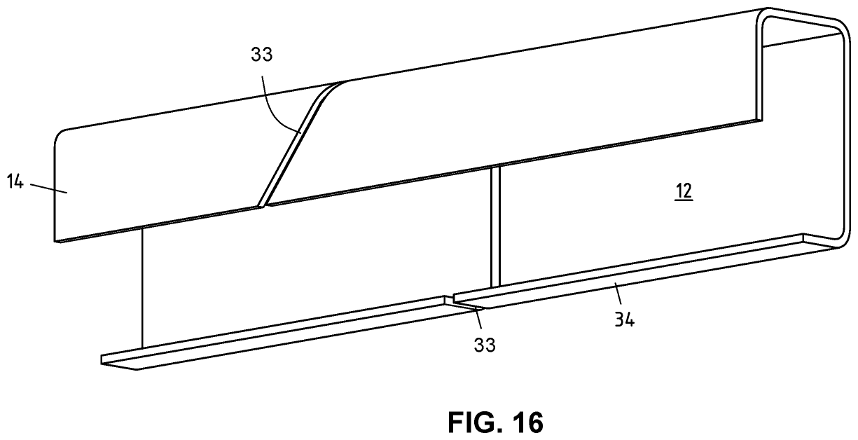

It can be seen that the gap 33 in the region of the running surface 16 is pivoted about the surface normal 16a, relative to a conventional gap, and that the gap 33 in the region of the guiding surface 18 is pivoted about the surface normal 18a, relative to a conventional gap, of the guiding surface 18. It can also be seen that the gap 33 runs parallel to the vertical axis 6 in the region of the mounting surface 20, as visible in FIG. 16 and described below.

The gap 33 preferably extends along a common first sectional plane in the region of the running surface 16 and the guiding surface 18 and along a third sectional plane that is different from the first sectional plane in the region of the mounting surface 20. The first sectional plane is preferably pivoted about both the surface normal 16a and the surface normal 18a. The third sectional plane preferably runs parallel to both surface normals 16a and 18a.

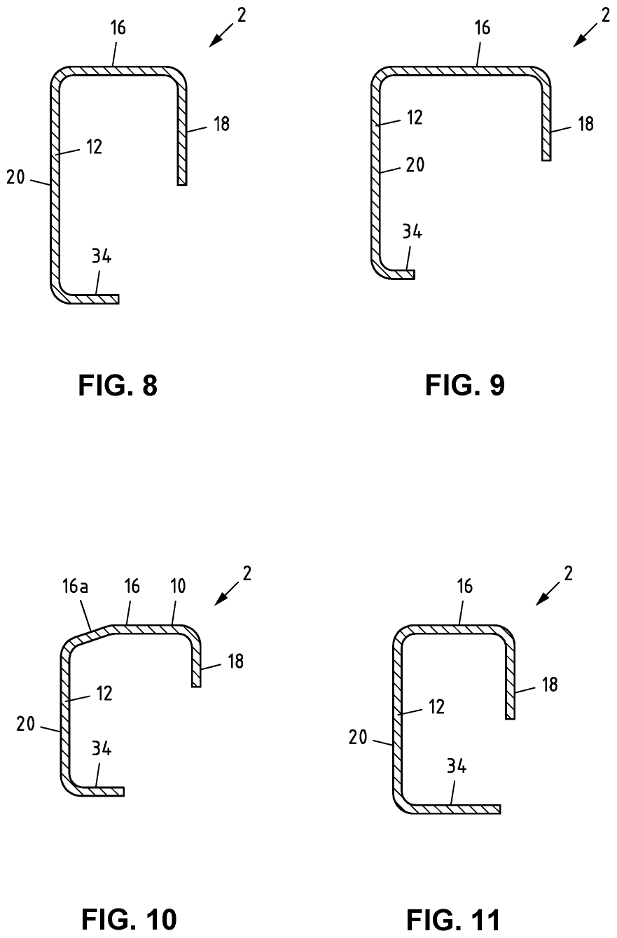

FIG. 7 shows an overall view of a rail 2. It can be seen that the front face edges 22 are cut along a sectional plane C at both ends 2a. Preferably, the sectional planes at the two ends 2a are parallel to each other. As used herein, including in the claims, the term “cut” is used to indicate a shape, angle, or plane that defines an end of an element, such as the end of a rail or the end of a leg of a rail, regardless how the element is created or shaped. The end of the leg or rail may be created and shaped by cutting the leg or rail from stock material, such as by a saw or laser, such as along a section plane. Alternatively, the end may be created and shaped by any other suitable manufacturing operation, such as milling, grinding, molding, forging, or forming.

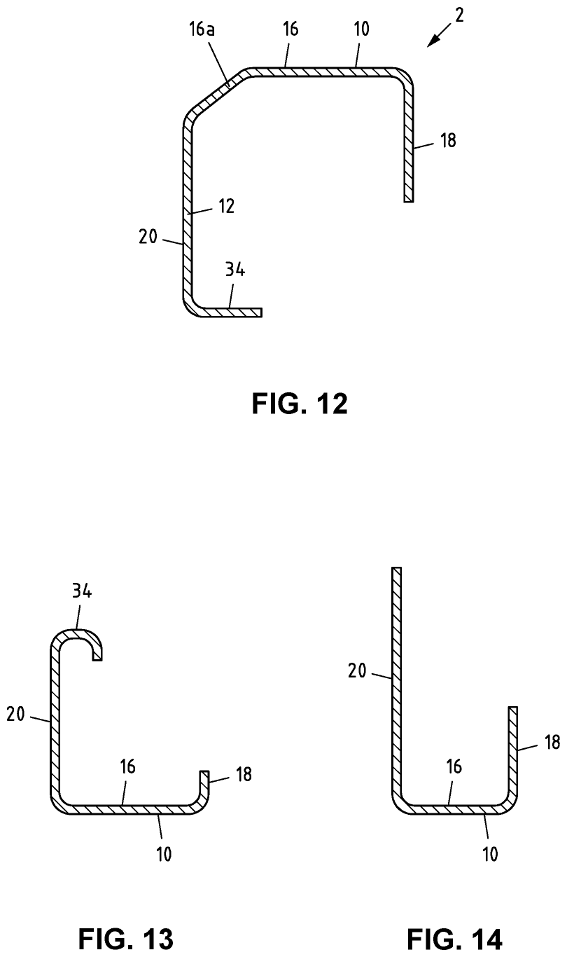

FIGS. 8-14 show various cross-sectional profiles of rails 2.

FIG. 8 shows a cross-sectional profile of a rail 2 with a running surface 16. A roller is moved on the running surface 16. A guiding surface 18 extends to the side of the running surface 16. The guiding surface 18 runs perpendicular to the running surface 16. Guide rollers are guided on the guiding surface 18. In particular, the guide rollers may be guided on either side or on both sides of the guiding surface 18. The mounting surface 20 is located on the opposite side of the guiding surface 18 in relation to the running surface 16. The mounting surface 20 runs parallel to the guiding surface 18. A folded edge 34 may be provided on the side of the mounting surface 20 facing away from the running surface 16. Slotted holes (not shown) are preferably defined in the rack upright leg 12 to enable mounting on a rack upright 24a.

In order to avoid misunderstandings, it should be noted that the running surface 16 can also be referred to as the running surface leg 10, the guiding surface 18 can also be referred to as the guiding surface leg 14 and the mounting surface 20 can be referred to as the rack upright leg 12. This applies to the entire description. It should also be noted that, in some contexts, the term “surface” does not refer to the geometric concept of a plane without extension in a depth direction, but is rather used as a designation for the flatly extending leg.

FIG. 9 shows a further embodiment of a rail 2. As can be seen in this cross-sectional profile, the running surface 16 is wider than in FIG. 8. The rail 2 shown in FIG. 8 is intended for storage machines with narrow rollers, whereas the rail 2 shown in FIG. 9 is intended for storage machines with wider rollers. In contrast to FIG. 8, the distance between guiding surface 18 and mounting surface 20 is greater. Otherwise, the two cross-sectional profiles do not differ significantly.

FIG. 10 shows a further embodiment in which an upper running surface 16 is provided. In contrast to FIGS. 8 and 9, the running surface leg 10 does not merge directly with a pivoting radius into the rack upright leg 12, but a transition area 16a is provided, which is inclined from the running surface 16 towards the mounting surface 20, which has an angle of inclination of less than 90°, in some embodiments less than 45°.

FIG. 11 shows a further embodiment which is similar to the embodiments shown in FIGS. 8 and 9. In contrast to FIGS. 8 and 9, the folded edge 34 is larger, i.e. has a greater extension in the transverse direction 8.

FIG. 12 shows a rail 2 similar to FIG. 10, whereby the running surface leg 10 is wider and the guiding surface leg 18 is longer. The rail 2 according to FIG. 10 is intended for storage machines with narrow rollers, whereas the rail 2 according to FIG. 12 is intended for storage machines with wider rollers.

In the embodiments shown in FIGS. 8-12, an electrical conductor rail (not shown) is preferably provided on the inside of the profile on the rack upright leg 12. The conductor rail can be single-phase or two-phase and is electrically insulated from the material of the rail 2.

A wiper electrode (not shown) of a storage machine (not shown) is disposed in the gap between the guiding surface 18 and the folded edge 34 and comes into contact with the conductor rail. This supplies the storage machine or its motor with electricity.

FIGS. 13 and 14 show embodiments in which the running surface 16 on the running surface leg 10 is on the inside, i.e. a roller is arranged inside the profile or the volume spanned by the profile and is moved on the running surface 16. In accordance with the previous embodiments, guiding surface 18 and mounting surface 20 with their respective legs 14, 12 are provided on the side of the running surface 16.

In FIG. 13, it can be seen that an inverted U-shaped double folded edge 34 is provided at the end of the mounting surface 20 facing away from the guiding surface 16, which provides additional stability.

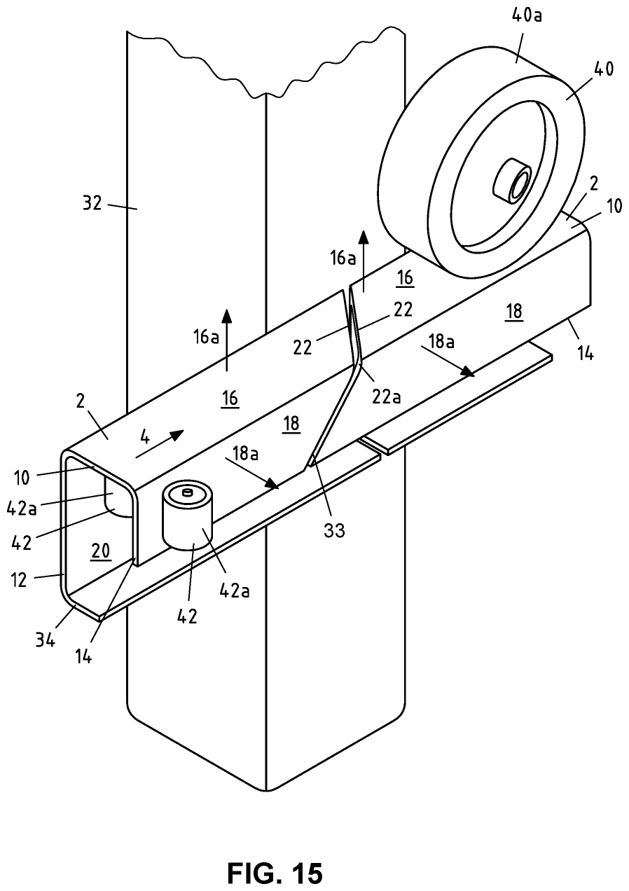

FIG. 15 shows a view of a rail 2 with a cross-sectional profile as shown in FIG. 8. FIG. 15 shows that a gap 33 is formed between two rails 2. The front face edges 22 of the adjacent rails 2 are pivoted, relative to conventional rail front face edges, in the area of the running surface 16 about the respective surface normals 16a of these running surfaces 16. In addition, the front face 22a of the respective rails 2 is inclined about the respective surface normal 18a of the respective guiding surfaces 18. These two inclinations form a sectional plane which is inclined relative to both the surface normal 16a and the surface normal 18a. This sectional plane runs through both the running surface leg 16 and the guiding surface leg 14. In particular, this is a uniform sectional plane.

The gap 33 also extends from the running surface leg 10 into the rack upright leg 12, i.e. the mounting surface 20. There, however, the gap 33 runs in a different sectional plane. This sectional plane preferably runs parallel to the two surface normals 16a, 18a and extends through the rack upright leg 12 and the folded edge 34. In other words, the front faces 22a run along the running surface leg 10 and guiding surface leg 14 along a first sectional plane and along the rack upright leg 12 and an optional folded edge 34 in a third sectional plane.

As can be seen, a roller 40 runs on the rails 2. The roller 40 is connected to a storage machine (not shown for clarity). The roller 40 is used to move the storage machine along the longitudinal axis 4. At a joint between two rails in the area of a rack upright 32, the gap 33 or the front face edges 22 and the front faces 22a of the adjacent rails 2 are cut as described. As a result, the roller 40 can be guided over the gap 33 without it being significantly immersed in the gap 33. Instead, the running surface 40a of the roller 40 preferably always rests on at least one of the running surfaces 16 of the two rails 2.

In order to be able to hold the track roller 40 with its track roller surface 40a on the running surface 16 during the movement, guide rollers 42 are arranged on both sides of the guiding surface leg 14. The guide rollers 42 are also connected to the storage machine. The guide rollers 42 slide or roll with their rolling surfaces 42a along the guiding surface 18 or the guiding surface leg 14. Corresponding to the track roller 40, the guide rollers 42 slide or roll over the gap 33 without having to plunge into the gap 33, since the gap 33 is cut in the manner described.

FIG. 16 shows the two rails 2 in a view from below. It can be seen how the gap 33 extends through the rack upright leg 12 and the folded edge 34. It can also be seen how the gap 33 on the guiding surface leg 14 is pivoted relative to the surface normal 18a.

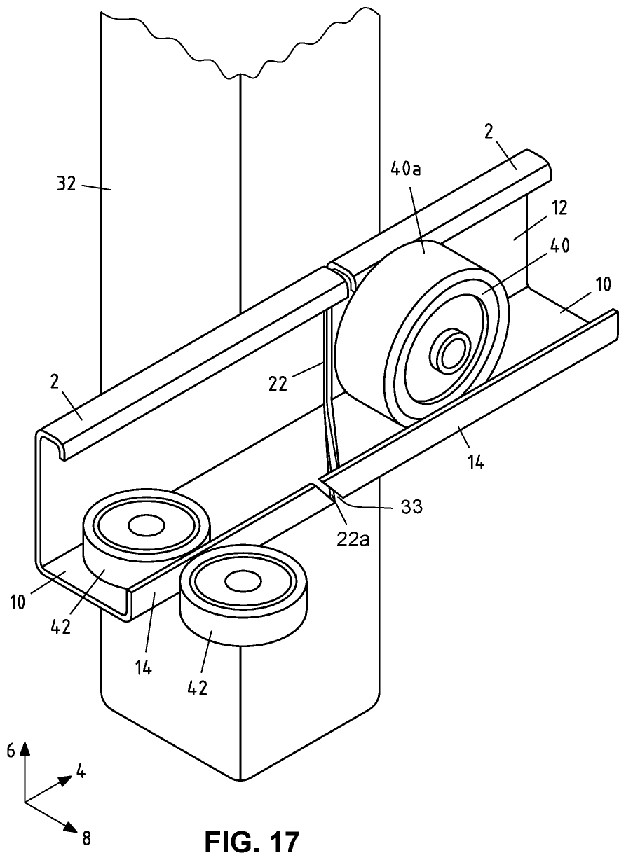

FIG. 17 shows a further example of a joint between two rails 2. In this case, the rails 2 are shaped with a cross-sectional profile as shown in FIG. 13. Once again, it can be seen that the gap 33 or the front face edges 22 and the front faces 22a in the region of the guiding surface leg 14 and the running surface leg 10 run along a first inclined sectional plane. Another sectional plane, which runs parallel to the vertical axis 6 and transverse axis 8, runs along the regulating upright leg 12.

In the example shown, the track roller 40 is guided on the inside of the running surface leg 10 and runs with its running surface 40a over the gap 33. The sectional plane described prevents the track roller 40 from plunging into the gap 33. The same applies to the guide rollers 42.

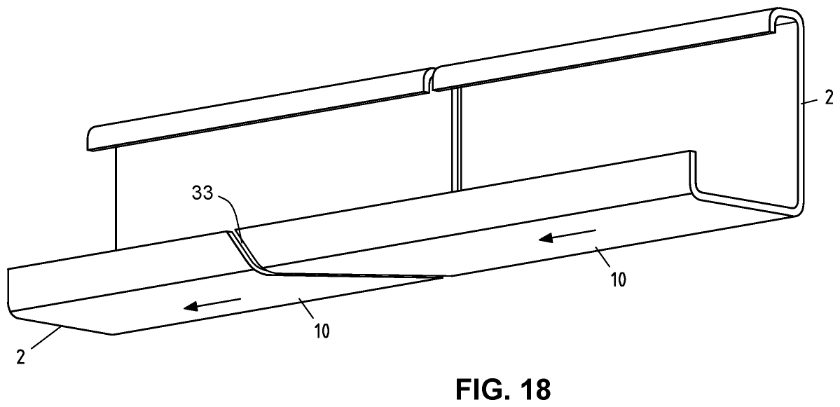

FIG. 18 shows the rails 2 as shown in FIG. 17 in a view from below. Here it can be seen how the gap 33 runs along a sectional plane inclined to the surface normals 16a and 18a through the running surface legs 10.

With the aid of the inclined sectional planes along the ends 2a or the front face edges 22 and the front faces 22a of the rails 2, mechanical loads on a rack are reduced by the movement of storage machines.

### Definitions

As used herein, the following term shall have the following meanings, unless context indicates otherwise.

While the invention is described through the above-described exemplary embodiments, modifications to, and variations of, the illustrated embodiments may be made without departing from the inventive concepts disclosed herein. For example, although specific parameter values, such as materials, dimensions, and shapes may be recited in relation to disclosed embodiments, within the scope of the invention, the values of all parameters may vary over wide ranges to suit different applications. Unless otherwise indicated in context, or would be understood by one of ordinary skill in the art, terms such as “about” mean within ±20%. Unless otherwise indicated in context, or would be understood by one of ordinary skill in the art, terms such as “essentially” mean within ±20°.

As used herein, including in the claims, the term “and/or,” used in connection with a list of items or categories, means one or more of the items or categories in the list, i.e., at least one of the items or categories in the list, but not necessarily all the items in the list and not necessarily one item from each category in the list. As used herein, including in the claims, the term “or,” used in connection with a list of items or categories, means one or more of the items or categories in the list, i.e., at least one of the items or categories in the list, but not necessarily all the items in the list and not necessarily one item from each category in the list. “Or” does not mean “exclusive or,” and “or” does not mean “at least one from each (category).”

As used herein, including in the claims, the term “adjacent” means next to or adjoining. Adjacent refers to a nearest item or a nearest item in a direction being referenced.

As used herein, including in the claims, an element described as being configured to perform an operation “or” another operation is met by an element that is configured to perform only one of the two operations. That is, the element need not be configured to operate in one mode in which the element performs one of the operations, and in another mode in which the element performs the other operation. The element may, however, but need not, be configured to perform more than one of the operations.

Disclosed aspects, or portions thereof, may be combined in ways not listed herein and/or not explicitly claimed. In addition, embodiments disclosed herein may be suitably practiced, absent any element that is not specifically disclosed herein. Accordingly, the invention should not be viewed as being limited to the disclosed embodiments.

As used herein, numerical terms, such as “first,” “second” and “third,” are used to distinguish respective section planes, legs, etc. from one another and are not intended to indicate any particular order or total number of section planes, legs, etc. in any particular embodiment. Thus, for example, a given embodiment may include, or be cut along, only a second section plane and a third section plane.

What is claimed is:

1. A rail for a rack of a rack storage system of the kind that includes a rack upright, wherein:
the rail extends along a longitudinal axis;
the rail has a cross-sectional profile with at least three legs, such that:
a first leg of the at least three legs is a running surface leg which, together with the longitudinal axis of the rail, spans a running surface for a storage machine and at each point along the rail, a transverse axis extends perpendicular to the longitudinal axis at the point and parallel to the running surface,
a second leg of the at least three legs is a guiding surface leg which, together with the longitudinal axis of the rail, spans a guiding surface, and
a third leg of the at least three legs is a rack upright leg which, together with the longitudinal axis of the rail, spans a mounting surface for the rack upright; and
the running surface leg is cut at a first front face edge of the rail by a first sectional plane, the first sectional plane being pivoted a non-zero angle, relative to the transverse axis, about a surface normal of the running surface.

2. The rail according to claim 1, wherein:
the first sectional plane is parallel to the surface normal of the running surface or
the first sectional plane is pivoted about the transverse axis.

3. The rail according to claim 1, wherein:
the first sectional plane is pivoted by 30° to 60° about the surface normal of the running surface and/or
the first sectional plane is pivoted by 30° to 60° about the transverse axis.

4. The rail according to claim 1, wherein the guiding surface leg is cut at a second front face edge of the rail by a second sectional plane, the second sectional plane being pivoted about the transverse axis.

5. The rail according to claim 4, wherein:
the second sectional plane is parallel to the transverse axis or
the second sectional plane is pivoted about the surface normal of the running surface.

6. The rail according to claim 4, wherein:
the second sectional plane is pivoted by 30° to 60° about the surface normal of the running surface and/or
the second sectional plane is pivoted by 30° to 60° about the transverse axis.

7. The rail according to claim 4, wherein the first and second sectional planes are identical.

8. The rail according to claim 1, wherein the rack upright leg is cut at a third front face edge of the rail by a third sectional plane, such that a surface normal of the third sectional plane is parallel to the longitudinal axis.

9. The rail according to claim 8, wherein the first, second and third sectional planes are parallel to one another.

10. The rail according to claim 4, wherein the first and second section planes are parallel to one another.

11. The rail according to claim 1, wherein:
the third leg comprises an L-shape such that a first portion of the third leg runs essentially parallel to the running surface and/or
the third leg comprises a U-shape such that a first portion of the third leg runs essentially parallel to the running surface and a second portion of the third leg runs essentially parallel to the mounting surface.

12. A rack storage system comprising:
a first rail that: extends along a longitudinal axis, has a cross-sectional profile with at least three legs, such that: a first leg of the at least three legs is a running surface leg which, together with the longitudinal axis of the rail, spans a running surface for a storage machine and at each point along the rail, a transverse axis extends perpendicular to the longitudinal axis at the point and parallel to the running surface, a second leg of the at least three legs is a guiding surface leg which, together with the longitudinal axis of the rail, spans a guiding surface, and a third leg of the at least three legs is a rack upright leg which, together with the longitudinal axis of the rail, spans a mounting surface for a rack upright; and the running surface leg is cut at a first front face edge of the rail by a first sectional plane, the first sectional plane being pivoted, relative to the transverse axis, about a surface normal of the running surface; and
a second rail that: extends along a longitudinal axis, has a cross-sectional profile with at least three legs, such that: a first leg of the at least three legs is a running surface leg which, together with the longitudinal axis of the rail, spans a running surface for a storage machine and at each point along the rail, a transverse axis extends perpendicular to the longitudinal axis at the point and parallel to the running surface, a second leg of the at least three legs is a guiding surface leg which, together with the longitudinal axis of the rail, spans a guiding surface, and a third leg of the at least three legs is a rack upright leg which, together with the longitudinal axis of the rail, spans a mounting surface for a rack upright; and the running surface leg is cut at a first front face edge of the rail by a first sectional plane, the first sectional plane being pivoted, relative to the transverse axis, about a surface normal of the running surface; wherein:
the first and second rails run in the longitudinal direction in a common rack plane and are arranged with their respective front face edges abutting each other such that the respective sectional planes of the first and second rails are substantially parallel to each other.

13. The rack storage system according to claim 12, comprising:
a plurality of first rails and a plurality of second rails, each first rail being adjacent a respective second rail to form a respective pair of adjacent first and second rails, each pair of adjacent first and second rails running in the longitudinal direction in a common rack plane and being arranged with their respective front face edges abutting each other such that:
the respective sectional planes of the respective first and second rails are substantially parallel to each other; and
a distance between their respective front face edges is less than 20 mm.

14. The rack storage system according to claim 13, wherein the distance between their respective front face edges is less than or equal to 12 mm.

15. The rack storage system according to claim 12, further comprising:
another first rail disposed in the common rack plane as, parallel to, and spaced in the transverse direction apart from the first rail, wherein the first rail and the other first rail collectively form a rail segment of an aisle.

16. The rack storage system according to claim 15, further comprising:
a plurality of rail segments running in a common rack plane parallel to a longitudinal axis of the rack plane and/or a plurality of rail segments running in a common rack plane transversely to the longitudinal axis of the rack plane and/or at least one rail segment that runs at a non-zero angle to the rack plane and connects two rack planes which are offset vertically relative to one another.
